(19) United States
(12) Patent Application Publication
(10) Pub. No.: US 2016/0126875 A1
(43) Pub. Date: May 5, 2016

(54) METHODS AND APPARATUS FOR ROTOR POSITION ESTIMATION

(71) Applicant: MAGNOMATICS LIMITED, Sheffield (GB)

(72) Inventors: Mohammed Bouheraoua, Sheffield (GB); Jiabin Wang, Nottinghamshire (GB); Kais Atallah, Sheffield (GB)

(21) Appl. No.: 14/890,029

(22) PCT Filed: May 8, 2014
(86) PCT No.: PCT/GB2014/051402

§ 371 Date: Nov. 9, 2015

(30) Foreign Application Priority Data
May 8, 2013 (GB) 1308270.6

(51) Int. Cl. H02P 21/14; H02P 21/13

(52) U.S. Cl. CPC H02P 21/146; H02P 21/13

(57) ABSTRACT

An apparatus and method for estimating the position of a rotor. An apparatus comprises a first rotor having an angular position, a second rotor which interacts with the first rotor in a magnetically geared manner, a sensor for measuring a kinematic property of the second rotor and means for estimating the angular position of the first rotor using a model-based observer, wherein the estimation is based on at least the kinematic property of the second rotor. A method of estimating the angular position of a first rotor comprises measuring a kinematic property of a second rotor, wherein the second rotor interacts with the first rotor in a magnetically geared manner; and estimating the angular position of the first rotor using a model-based observer based on at least the kinematic property of the second rotor.

### FIELD OF THE INVENTION

The present invention relates to an apparatus and method for estimating the position of a first rotor which interacts with a second rotor in a magnetically geared manner.

### BACKGROUND

Magnetic gears are well-known alternatives to conventional mechanical gears. Although nominally the relative speed of the two rotors in a magnetic gear is given by the gear ratio, the magnetic gear typically has relatively low stiffness and non-linear characteristics. Unlike conventional mechanical gears, the gear ratio cannot be used to relate accurately one rotor position to the other since it may not hold in transients or under load conditions, particularly as the relative angles between the rotors/fields are torque dependant. Given these complications, it is not possible to determine the position of one rotor from the position of another rotor simply using the gear ratio.

Permanent magnet synchronous AC motors typically have permanent magnets on the rotor and windings on the stator. They are typically controlled using inverters employing field oriented control (FOC), which requires rotor position in order to produce the current waveforms to drive the motor. The position of the rotor is usually obtained by direct measurement using devices such as a resolver or encoder on the output shaft. Using the rotor position, FOC ensures the flux is correctly oriented with the phase currents for optimum torque production. Therefore, the pulse width modulation (PWM) is regulated by FOC. For example, it ensures the phase relationship or angle between the rotor position and the demanded three phase currents, which are temporally distributed by 120° which flow in a 3 phase winding that is 120° spatially distributed (electrical degrees), to create a rotating stator flux axis which is orthogonal (90°) to the rotor flux axis.

The Pseudo Direct Drive (PDD) 1 is a permanent magnet machine which has an integrated magnetic gear; examples of PDD machines are described in detail in WO 2007/125284 A1. PDD machines are useful for matching the operating speed of prime-movers to the requirements of their loads, in applications such as wind-powered generators and electric ship propulsion arrangements. A first rotor 10 carries an array of permanent magnets and interacts with windings 34 in the stator 30 to produce torque. Typically, a second rotor 20, located between the stator 30 and first permanent magnet rotor 10, comprises an array of ferromagnetic pole-pieces 22. The second rotor 20 typically rotates at a lower speed than the first rotor 10 due to the principle of magnetic gearing caused by the interaction of a static array of permanent magnets 32 on the stator 30 with spatial harmonics created in the magnetic field as the magnetic flux from the first rotor 10 passes through the second rotor 20. However, the second rotor 20 may rotate at a higher speed than the first rotor 10 in some embodiments. The gear ratio is determined by the ratio of the number of pole-pieces 22 to the number of pole-pairs on the permanent magnet rotor 10. The first rotor 10 will be referred to throughout as the high-speed rotor 10, and the second rotor 20 referred to as the low-speed rotor 20.

For the PDD drive to perform motor control using FOC, the position of the high-speed rotor 10 is required. For small size PDDs the high speed rotor 10 can be made accessible for fitting a position sensor with a mechanical arrangement as shown in FIG. 1. With an accessible high-speed rotor 10 the PDD may employ FOC using the directly measured position of the high-speed rotor 10.

However, for large PDDs this design cannot necessarily be implemented due to the large amount of stress applied on the shaft and bearings and also the twisting forces applied to the pole-piece structure if torque is only reacted at one end of the shaft. To provide a robust mechanical design, it is preferable for the high-speed rotor to be fully enclosed by the low-speed rotor. However, in this case the high-speed rotor is not accessible, and the position of the rotor may not be directly measured for FOC. The only available shaft for fitting a measurement sensor is the low-speed rotor which is the output rotor connected to the load. However, the measurement obtained from this rotor cannot be directly used for FOC, as this does not reflect the high-speed rotor position due to the effects described above, such as gear ratio, low stiffness and non-linearity of the magnetic coupling.

The present invention addresses this problem by providing an apparatus and method for estimating the position of a first rotor using a model-based observer based on the measurement of a kinematic property of a second rotor which interacts with the first rotor in a magnetically geared manner.

### SUMMARY OF THE INVENTION

In accordance with the present invention, there is provided an apparatus comprising a first rotor having an angular position, a second rotor which interacts with the first rotor in a magnetically geared manner, a sensor for measuring a kinematic property of the second rotor and means for estimating the angular position of the first rotor using a model-based observer, wherein the estimation is based on at least the kinematic property of the second rotor.

The measured kinematic property of the second rotor may be angular position and/or angular velocity.

The model-based observer may preferably be a reduced-order model-based observer. The model implemented in the model-based observer may incorporate any combination of gearing effect, stiffness variation and/or inertia. Preferably, the model may incorporate gearing effect, stiffness variation and inertia.

Wherein the measured kinematic property of the second rotor comprises angular position, the means for estimating the angular position of the first rotor may comprise means for estimating the referred angle between the first rotor and the second rotor using a model-based observer and calculating the angular position of the first rotor from the estimated referred angle and measured angular position of the second rotor.

The first rotor may not be accessible for measurement of its kinematic properties. The first rotor may be enclosed by the second rotor.

The first rotor may comprise a first plurality of permanent magnets. The apparatus may further comprise a stator with windings which interact with the first plurality of permanent magnets. The stator may further comprise a second plurality of permanent magnets and the second rotor may comprise a plurality of pole pieces.

The estimation of the angular position of the first rotor may be further based on at least one input to the apparatus. The estimation may be further based on the current in the windings. The estimation may be further based on the electromagnetic torque produced by the windings.

The apparatus may further comprise a drive system adapted to employ field oriented control based on the estimated angular position of the first rotor. The apparatus may further comprise means for transforming the estimated angular position into a signal in the format of an output of an angular position sensor. The apparatus may further comprise means for converting the estimated angular position to a sin and/or cosine waveform. The apparatus may further comprise means for modulating the waveform by a high-frequency sine wave to create a modulated signal. The apparatus may further comprise a drive system adapted to employ field oriented control based on the modulated signal.

There is further provided a method of estimating the angular position of a first rotor comprising measuring a kinematic property of a second rotor, wherein the second rotor interacts with the first rotor in a magnetically geared manner; and estimating the angular position of the first rotor using a model-based observer based on at least the kinematic property of the second rotor.

The kinematic property of the second rotor may comprise angular position and/or angular velocity.

The model-based observer may be a reduced-order model-based observer. The model implemented in the model-based observer may incorporate any combination of gearing effect, stiffness variation and/or inertia. Preferably, the model may incorporate gearing effect, stiffness variation and inertia.

Wherein the kinematic property of the second rotor comprises angular position, the step of estimating the angular position of the first rotor may comprise estimating a referred angle using a model-based observer and calculating the angular position of the first rotor from the estimated referred angle and measured angular position of the second rotor.

The first rotor may not be accessible for measurement of its kinematic properties. The first rotor may be enclosed by the second rotor.

The first rotor may comprise a first plurality of permanent magnets. The first plurality of permanent magnets may interact with windings on a stator. The stator may further comprise a second plurality of permanent magnets and the second rotor may comprise a plurality of pole pieces.

The estimation may be further based on at least one input. The estimation may be further based on the current in the windings. The estimation may be further based on the electromagnetic torque produced by the windings.

The method may further comprise employing field oriented control of the first rotor based on the estimated angular position of the first rotor. The method may further comprise converting the estimated angular position into a signal in the format of an output of an angular position sensor. The method may further comprise converting the estimated angular position to a sin and/or cosine waveform. The method may further comprise modulating the waveform by a high-frequency sine wave to create a modulated signal. The method may further comprise employing field oriented control of the first rotor based on the modulated signal.

### BRIEF DESCRIPTION OF THE DRAWINGS

Embodiments of the present invention will now be described in detail by way of example with reference to the following figures in which:

FIG. 1 shows a cross-sectional view of a pseudo direct drive machine with an accessible high-speed rotor;

FIG. 2 shows a cross-sectional view of a pseudo direct drive machine with an inaccessible high-speed rotor;

FIG. 3 is a graph of referred angle against load torque for a typical pseudo direct drive machine;

FIG. 4 is a graph of stiffness against load torque for a typical pseudo direct drive machine;

FIG. 5 shows the variation of the measured and estimated angular positions of the high-speed rotor of a pseudo direct drive machine with time, wherein the angular position was estimated by integrating an estimated speed of the high-speed rotor;

FIG. 6 shows the variation of the measured and estimated angular positions of the high-speed rotor of a pseudo direct drive machine with time, wherein the angular position was estimated using the estimated referred angle and the measured position of the low-speed rotor;

FIGS. 7A, 7B and 7C schematically show possible hardware implementations of apparatus which estimates the position of the high-speed rotor of pseudo direct drive machine and converts the estimated position to a signal mimicking a resolver or encoder;

FIG. 8 shows a representation of apparatus for estimating the angular position of a high-speed rotor and emulating a resolver or encoder signal;

FIG. 9 shows the structure of a reduced order observer;

FIG. 10 is a schematic of an example of closed-loop speed control of a pseudo direct drive machine using low-speed rotor sensor and real-time control;

FIG. 11A shows the load torque variation with time for a test performed on a pseudo direct drive machine;

FIG. 11B shows the measured speed of the low-speed rotor during the test;

FIG. 11C shows the measured and estimated speeds of the high-speed rotor during the test;

FIG. 11D shows the i_{q} component of the current during the test; and

FIG. 11E shows the i_{d} component of the current during the test.

### DETAILED DESCRIPTION

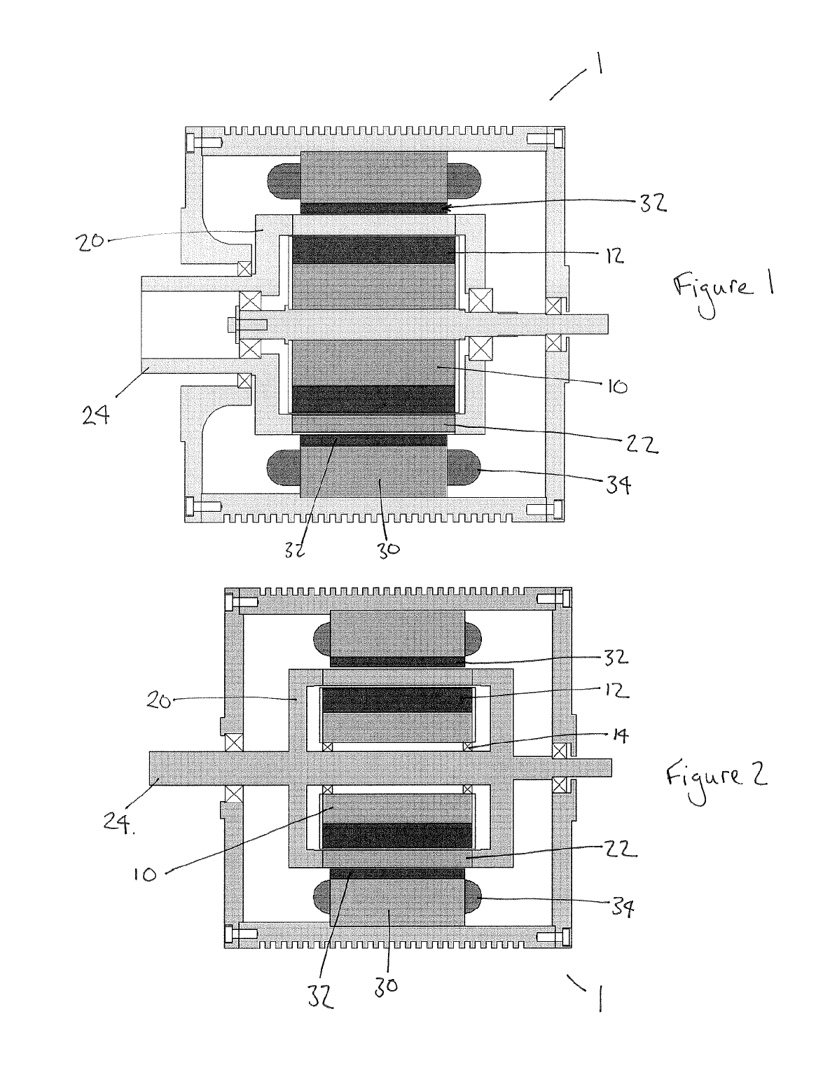

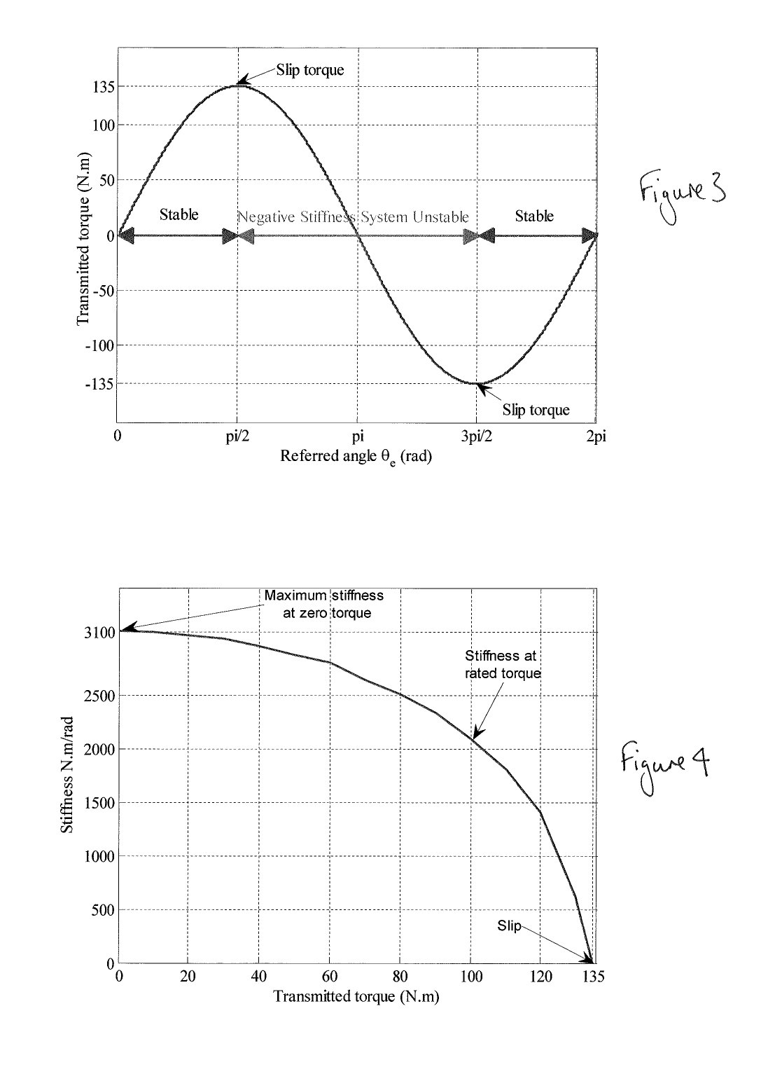

A typical Pseudo Direct Drive 1 with an inaccessible high-speed rotor 10 is shown in FIG. 2. The high-speed rotor 10 comprises a plurality of permanent magnets 12, and is located within the low-speed rotor 20 which comprises an array of ferromagnetic pole-pieces 22. The high-speed rotor 10 and low-speed rotor 20 interact in a magnetically geared manner with permanent magnets 32 mounted on the stator 30. The gear ratio of the magnetically geared interaction is determined by the ratio of the number of pole pairs on the high-speed rotor 10 to the number of pole-pieces 22 mounted on the low-speed rotor 20. The stator 30 further comprises windings 34, which interact with the fundamental, or first harmonic, of the magnetic field of the high-speed rotor 10.

As shown in FIG. 2, the high-speed rotor 10 is fully enclosed or enveloped by the low-speed rotor 20, and rotates on bearings 14 mounted on the rotating shaft 24 of the low-speed rotor 20. In this arrangement, it is impractical to measure directly the angular position of the high-speed rotor 10 since it is not possible to provide electrical connections or leads to a position sensor through the enveloping low-speed rotor 20.

As described above, the low stiffness and non-linearity of the magnetic gearing means that it is not possible to accurately estimate the position of the high-speed rotor from the position of the low-speed rotor simply using the gear ratio. FIG. 3 shows a typical relationship between the referred angle (defined as νₑ=pₕθₕ−nₛθₒ, where θₕ and θₒ are the angular positions of the high-speed rotor 10 and low-speed rotor 20 respectively, pₕ is the number of pole pairs on the high-speed rotor 10 and nₛ is the number of pole pieces on the low-speed rotor 20) and load torque, which can be described over the stable operating regions by a sinusoidal function. When the referred angle is between pi/2 and 3pi/2 radians, the stiffness of the magnetic gear is negative, and the system is unstable. FIG. 4 shows a typical relationship between the stiffness of the magnetic gear and the load torque. As shown, the stiffness decreases with increasing load torque.

The position of the high-speed rotor 10 may be estimated using a model-based observer. The observer is a mathematical representation of the PDD 1. The observer model may be linear or non-linear, and reflects the dynamics of the PDD 1. The observer model may reflect the gearing effect, stiffness change, or inertia or any combination thereof. Preferably, the observer model reflects the gearing effect, stiffness change and inertia. The observer model may also reflect the damping effect associated with the referred angular speed between the high-speed rotor 10 and the low-speed rotor 20 due to eddy current loss in the high-speed rotor 10 and iron loss in the low-speed rotor 20, although this effect is typically small and may be neglected. Suitable model-based observers include a full-order observer, a reduced order observer, a kalman filter or an extended kalman filter. The observer links the controllable inputs to the apparatus, such as current demand, and the measurable states, such as kinematic properties (for example, angular position or speed) of the low speed rotor, with states which are not accessible for measurement. Therefore, it is possible for the observer to estimate the states of the PDD which are not accessible for measurement, such as the speed of the high-speed rotor 10 and the referred angle which describes the position of the high-speed rotor 10 relative to the low-speed rotor 20.

With an observer which provides estimates for the speed of the high-speed rotor 10 and the referred angle, the position of the high-speed rotor 10 may be estimated. Assuming an accurate speed estimation has been obtained by the observer, in order to estimate the position of the high-speed rotor 10, direct integration may be performed on the estimated speed. However, as shown in FIG. 5, direct integration of speed results in angular position drifting from the true angle, due to a small estimation error being accumulated with direct integration of speed.

Preferably, an estimation of the position of the high-speed rotor 10 may be obtained using the estimated referred angle, and a measured position of the low-speed rotor 20. This results in an estimated high-speed rotor position with a significantly lower error than the position calculated by direct integration of the estimated speed.

Equations that describe the motion of the high-speed rotor 10 and low-speed rotor 20 in a PDD 1 may be written as follows:

$$\begin{matrix}\frac{d {ω}_{h}}{d t} = \frac{{T}_{e}}{{J}_{h}} - \frac{{T}_{max}}{{J}_{h} {G}_{r}} sin ( {θ}_{e} ) - \frac{{B}_{h}}{{J}_{h}} {ω}_{h} & ( 1 ) \\ \frac{d {ω}_{o}}{d t} = \frac{{T}_{max}}{J} sin ( {θ}_{e} ) - \frac{{B}_{o}}{J} {ω}_{O} - \frac{{T}_{L}}{J} & ( 2 ) \\ {θ}_{e} = {p}_{h} {θ}_{h} - {n}_{s} {θ}_{o} & ( 3 )\end{matrix}$$

where ωₕ,Jₕ,Bₕ are the angular speed, the moment of inertia and the viscous damping of the high-speed rotor 10 respectively, ωₒ,J,Bₒ are the angular speed, the combined inertia of the low-speed rotor 20 and the load, and the combined damping coefficient of the low-speed rotor 20 and the load respectively. θₑ is defined as the referred angular displacement between the high-speed rotor 10 and the low-speed rotor 20, θₕ and θₒ are the angular positions of the high-speed rotor 10 and low-speed rotor 20 respectively, pₕ is the number of pole pairs on the high-speed rotor 10, nₛ is the number of pole pieces on the low-speed rotor 20 and

$${G}_{r} = \frac{{n}_{s}}{{p}_{h}}$$

is the gear ratio. Tₑ, Tₘₐₓ and T_{L} are the electromagnetic torque, pull-out torque and load torque respectively, and t is time.

As discussed above, in an embodiment of the present invention the PDD drive configuration employs a single sensor attached to the low-speed rotor. Internal states are not accessible for measurement, hence, a model based observer (such as a full order observer, reduced order observer, kalman filter, extended kalman filter, etc.) may be implemented to estimate the unmeasured states, in this case ωₕ, θₑ and T_{L}.

The estimated position of the high-speed rotor \hat{θ}ₕ may be obtained by integrating the estimated speed ωₕ. FIG. 5 shows typical measured and estimated commutation angles where the PDD is in steady state; a noticeable difference may be seen between the measured and estimated commutation angles due to phase delay in the speed estimation and the accumulation of the estimation error through the integration. The error increases greatly in transient and under load change condition, which can lead to loss of commutation and consequently loss in power transmission.

Preferably, the angular position of the high-speed rotor may be calculated using measured position of the low-speed rotor 20 and the estimated referred angle as follows

$${\hat{θ}}_{h} = \frac{1}{{p}_{h}} {\hat{θ}}_{e} + \frac{{n}_{s}}{{p}_{h}} {θ}_{o} .$$

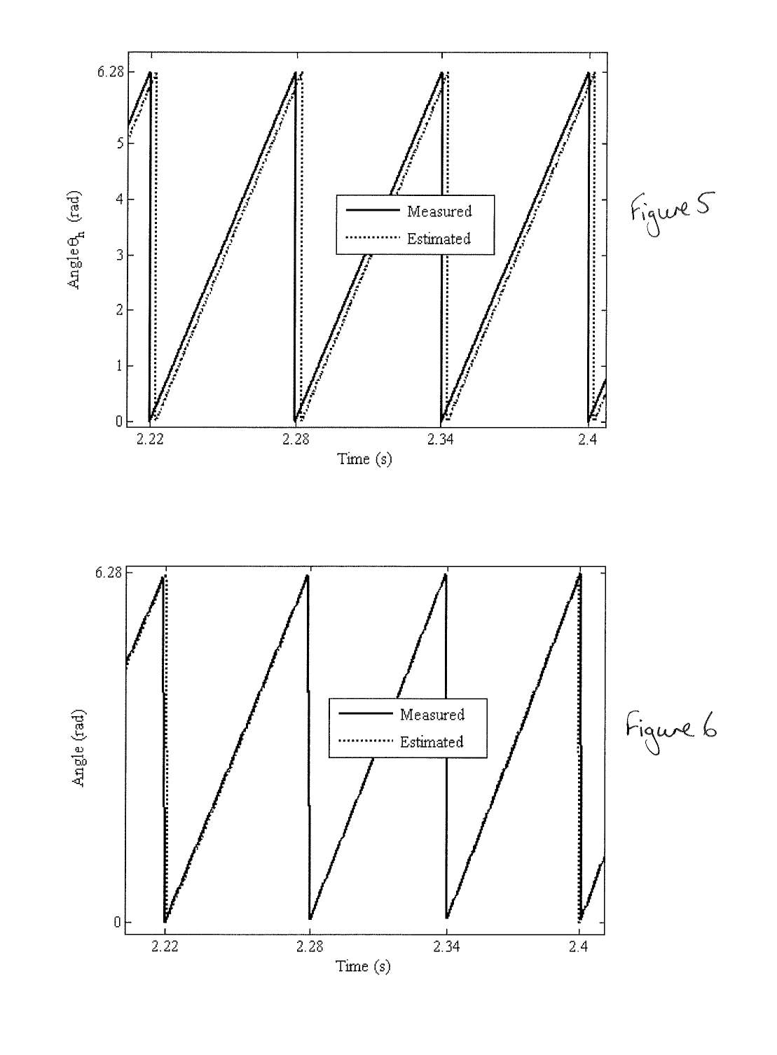

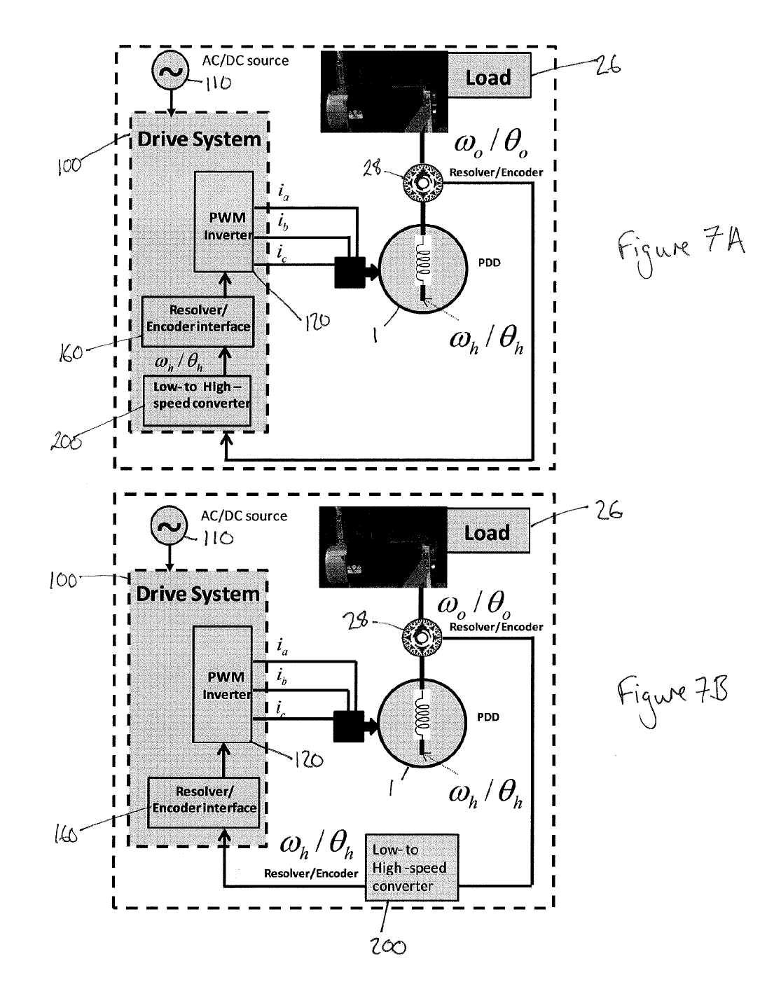

FIG. 6 shows the measured angular position θₕ of a high-speed rotor 10 and the estimated \hat{θ}ₕ obtained using this method. It is evident that the estimation error has been significantly reduced to less than 1%. By employing a robust observer and hardware herein described, the commutation signal required for field oriented control of the PDD machine may have the same quality as that of a position sensor mounted on the high-speed rotor 10. It should be emphasised that the quality of this observer is crucial since an incorrect commutation angle may result in the drive operation deviating from the maximum torque per amp condition, or loss of torque control altogether, which may eventually result in instability.

Field oriented control provides currents in synchronisation with the high-speed rotor position. In known configurations where the position of the high-speed rotor 10 is measured using a resolver or encoder sensor, the position of the rotor 10 may be transported directly to the drive in the form of sine and cosine waveforms, or in digital pulses format in the case of an encoder. The transformation from those signals to an absolute rotor position is performed internally within the drive using demodulation algorithms methods such as phase locked loop. Thus the demodulated signal is employed to generate pulse width modulation (PWM) required for phase currents and rotor synchronisation.

However, in accordance with an embodiment of the present invention, the position of the high-speed rotor 10 may be estimated using a model-based observer. Since commercial drives have been designed to operate with certain measurement devices such as a resolver or encoder etc., it may be necessary to reconstruct the signal in the same format as would be obtained by a measurement device such as a resolver or encoder prior to inputting it to a commercial drive. FIGS. 7A, 7B and 7C all show potential hardware implementations comprising a drive system 100, powered by an AC or DC source power supply 110; a load 26 connected to a low-speed rotor 20; and a sensor 28 (for example, a resolver or encoder) to measure the angular speed and/or angular position of the low-speed rotor. In the embodiments shown, the drive system 100, comprises a PWM inverter 120 which supplies current to the windings 34; and a resolver/encoder interface 160. The hardware further comprises a low-to high-speed converter 200 or adapter, which comprises means for estimating the angular position and/or angular velocity of the high-speed rotor based on at least the measured angular velocity or angular position of the low-speed rotor. The low- to high-speed converter 200 may be incorporated into the drive system 100, as shown in FIG. 7A. Alternatively, the low- to high-speed converter 200 may be a stand-alone component as shown in FIG. 7B. Alternatively, the low- to high-speed converter may be integrated with the sensor 28 as shown in FIG. 7C.

The implementation of the system in FIG. 7A may be preferred due to its simplicity. In this case, the PDD 1 is connected to the drive system 100 and operated like any permanent magnet machine with commercial drive and any off-the-shelf sensor 28. However, this requires the drive system 100 to have software modifications in order to include a low- to high-speed converter 200 in the drive system 100.

Alternatively, the implementation of the system in FIG. 7B may be preferred since it requires no modification of the hardware, drive system 100 or sensor 28. The converter 200 in this case may be a stand-alone component between the sensor 28 and the drive system 100. In the converter 200, the signal is converted into a high-speed signal and fed to the drive system 100. This implementation may not be preferred in applications where noise and/or harsh environmental conditions are present. Furthermore the cabling system between the sensor 28 and the drive system 100 must be modified, and independent power may have to be provided to the converter 200. However, depending on the required application and the drive model, the drive system 100 may provide power to the converter 200.

Alternatively, the implementation of the system in FIG. 7C may be preferred since the complexity and modification may be embedded within the sensor 28. Unlike the implementation shown in FIG. 7B, this implementation avoids the requirement of modifying the cabling system where connection and noise problems may occur. Also, in contrast to the implementation shown in FIG. 7A, the drive system 100 in this implementation does not require modification, so the PDD 1 may be operated by any off-the-shelf drive system 100 that satisfies the rating and requirements of a normal permanent magnet machine. However, the sensor 28 has to be designed to accommodate the extra hardware of the converter 200. Furthermore, sensor size may increase, and new packaging systems may be required. Heat, noise and vibration may also cause problems, again depending on application and working environment.

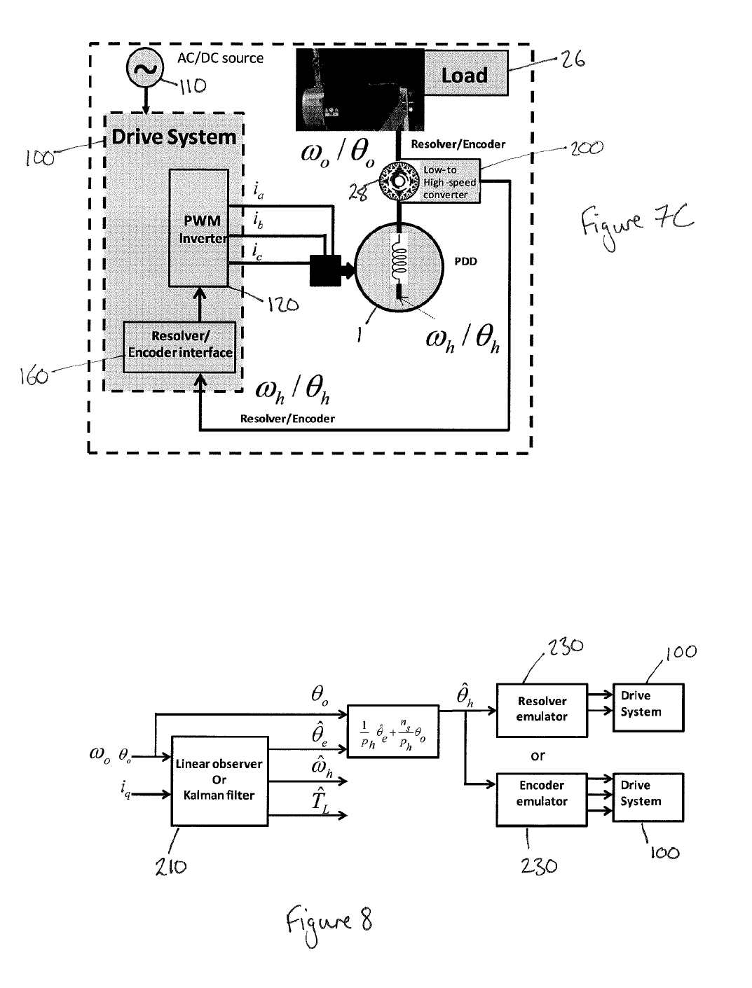

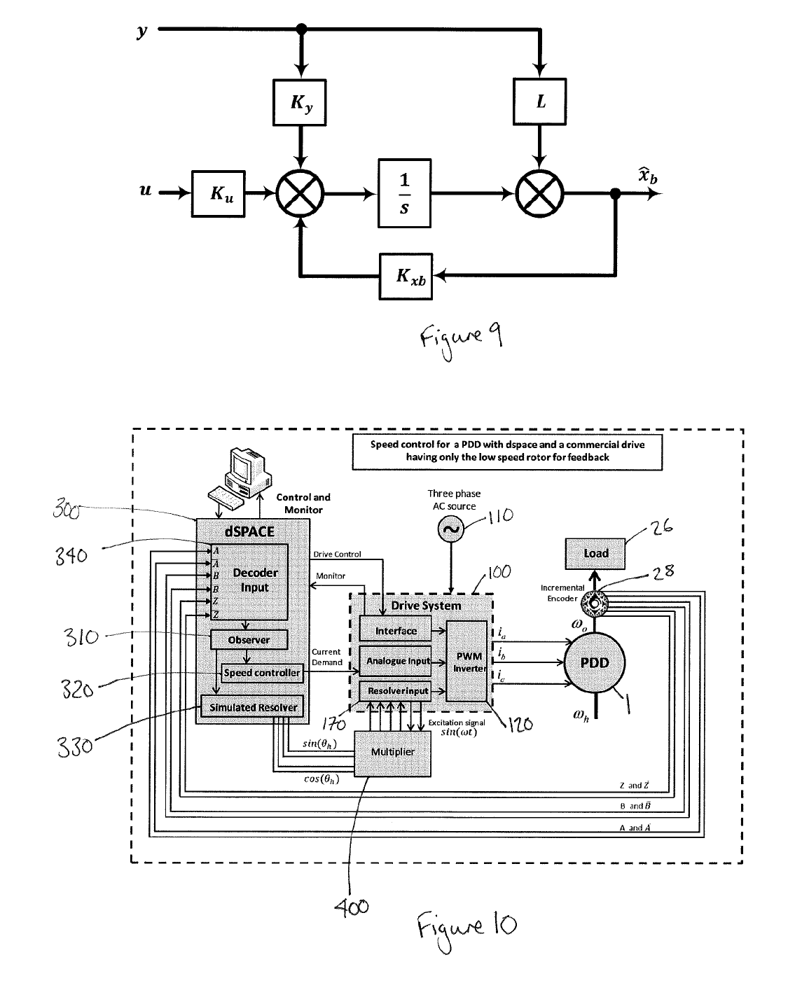

Therefore, the position of the high-speed rotor may be estimated (based on, for example, the model shown in equations (1)-(3)) with the aid of an observer, and the estimated angle may be converted by hardware and/or software to reconstruct a signal to mimic a resolver or encoder depending on the drive sensor input configuration. A schematic illustration of the process of estimating the position of the high-speed rotor using an observer 210, converting the estimated position into a signal which mimics the output of a resolver or encoder using an emulator 230 and using the signal as an input to the drive system 100 is found in FIG. 8.

For operating a PDD with a commercial off-the-shelf drive, the estimated position of the high-speed rotor 10 may be converted to a format acceptable by the drive system 100. For example, the estimated angular position from the observer may be converted to sin and cosine waveforms and modulated by a high frequency sine wave coming from the drive; the modulated signal may then be fed to the drive resolver input such that the drive will behave as though the signal has been received from a hardware sensor such as a resolver or encoder.

The hardware and/or software that performs low- to high-speed conversion may be implemented in different ways depending on the application, mechanical constraints and the hardware available. For example, the hardware and software may be implemented in a standalone FPGA card to take input from the resolver/encoder sensor 28 fitted on the low-speed rotor 20 and output a resolver/encoder signal representing the speed/position of the high-speed rotor 10 to the drive system 100. Similarly the FPGA may be built within the drive system 100, or it could be included with the sensor 28 as sensor 28 and FPGA in one enclosure.

The gain of the observer may be determined using any suitable method, such as manual tuning, pole placement or a genetic algorithm. Preferably, the gain may be tuned with a genetic algorithm (GA), details about this tuning method may be found in M. Bouheraoua, J. Wang, and K. Atallah, “Observer based state feedback controller design for Pseudo Direct Drive using genetic algorithm,” in Power Electronics, Machines and Drives (PEMD 2012), 6th IET International Conference on, 2012, pp. 1-6.

In order to successfully estimate the position of the high-speed rotor, feedback signals for ωₕ, θₑ and T_{L} are necessary. However, direct measurements of these signals are not available. The reduced order observer shown in FIG. 9 is employed to reconstruct the unavailable part of the state vector for the system given by (4), from the available outputs, y, and controls, u. These estimations are also necessary to obtain the electronic commutation signal needed for the PDD operation, since the high-speed rotor is not accessible for measurement.

The equations governing the model-based observer are

\dot{x}=f(x)+Bu+w(t)

y=Cx+v(t), (4)

where

$$x = [ {x}_{a} {x}_{b} ] \\ {x}_{a} = {ω}_{o} \\ {x}_{b} = {[ {ω}_{h} , {θ}_{e} , {T}_{L} ]}^{T} \\ B = {[ 0 , \frac{1}{{J}_{h}} , 0 , 0 ]}^{T} \\ C = [ 1 , 0 , 0 , 0 ] \\ U = {T}_{e} \qquad ( 5 )$$

w(t) is the process noise associated with model uncertainties and v(t) represent the measurement noise. x and y denote the state vector and output vector, respectively. Assuming that all damping effect is negligible and the rate of change of the load torque is zero or it changes relatively slowly compared to the dynamic response of the observer, the vector function f (x) is given by:

$$f ( x ) = {[ {f}_{1} ( x ) , {f}_{2} ( x ) , {f}_{3} ( x ) , {f}_{4} ( x ) ]}^{T} \\ {f}_{1} ( x ) = \frac{{T}_{max}}{J} sin ( {θ}_{e} ) - \frac{{T}_{L}}{J} \\ {f}_{2} ( x ) = - \frac{{T}_{max}}{{J}_{h} {G}_{r}} sin ( {θ}_{e} ) \\ {f}_{3} ( x ) = - {n}_{s} {ω}_{o} + {p}_{h} {ω}_{h} \\ {f}_{4} ( x ) = 0 \qquad ( 6 )$$

The Jacobian matrix

$$F ( x ) = \frac{\partial f ( X , U )}{\partial X}$$

is given by:

$$F ( x ) = [ \begin{matrix}0 & 0 & \frac{{T}_{max}}{J} cos ( {θ}_{e} ) & - \frac{1}{J} \\ 0 & 0 & - \frac{{T}_{max}}{{J}_{h} {G}_{r}} cos ( {θ}_{e} ) & 0 \\ - {n}_{s} & {p}_{h} & 0 & 0 \\ 0 & 0 & 0 & 0\end{matrix} ] \qquad ( 7 )$$

The relevant observer gain matrices are given below:

$${K}_{xb} = {A}_{bb} - {LA}_{ab} \\ {K}_{y} = {A}_{ba} - {LA}_{aa} \\ {K}_{u} = {G}_{b} - {LG}_{a} \\ {A}_{bb} = [ \begin{matrix}0 & - \frac{{T}_{max}}{{J}_{h} {G}_{r}} cos ( {θ}_{er} ) & 0 \\ {p}_{h} & 0 & 0 \\ 0 & 0 & 0\end{matrix} ] \\ {A}_{ab} = [ \begin{matrix}0 & \frac{{T}_{max}}{J} cos ( {θ}_{er} ) & - \frac{1}{J}\end{matrix} ] \\ {A}_{ba} = {[ 0 , - {n}_{s} , 0 ]}^{T} \\ {A}_{aa} = [ 0 ] \\ {G}_{a} = 0 \\ {G}_{b} = {[ \frac{1}{{J}_{h}} , 0 , 0 ]}^{T} \qquad ( 8 )$$

where θₑᵣ is the referred angle at the rated torque.

The observer design involves finding the observer gain matrix L which may be selected to place, arbitrarily, the eigenvalues of K_{xb} and, hence, modifies the behaviour of the state estimation error. The poles of the observer are typically placed far to the left of the dominant poles of the closed loop state feedback system. Thus the speed, ωₒ, of the low-speed rotor is directly measured through an encoder and the speed of the high-speed rotor ωₕ, the referred angle θₑ and the load torque T_{L} are estimated from the observer. The observer gain L may be tuned with GA such that the error between the observer output and the simulated system output is minimised. The tuned observer gain matrix L is specific to a particular PDD 1, since its values depend on the parameters of the system, such as inertias, gear ratio, damping, stiffness, etc.

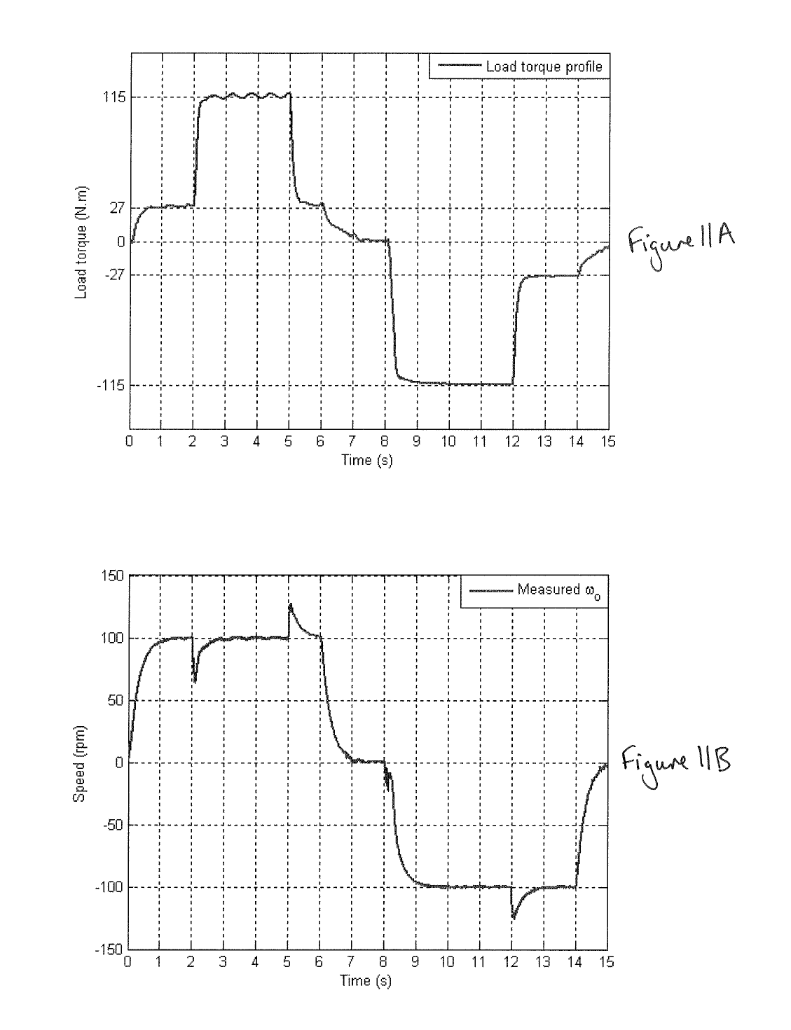

FIG. 10 shows a schematic example of a possible real-time realisation of a feedback system where only the low-speed rotor is available for measurements. The speed/position of the low-speed rotor 20 attached to the load 26 is measured using an incremental encoder 28; the measured signal is passed via the decoder input 340 to dSPACE real time controller 300, where an algorithm is executed to determine the position of the high-speed rotor 10 using an observer 310. A simulated resolver 330 converts the estimated position \hat{θ}ₕ shown in FIG. 6 to sine and/or cosine waveforms with the amplitude specified by the drive resolver input 170 and further modulated by an 8 kHz sine wave supplied from the drive resolver interface. In this manner, the drive system 100 may receive reconstructed resolver-like signals as if supplied from a hardware resolver. The drive system 100 performs current regulation and electronic commutation via a 3-phase inverter by using the position signal from the multiplier 400 and the i_{q} current demand sent by the speed controller 320 in dSPACE 300.

A PDD has been tested under rated torque conditions using the setup shown in FIG. 10, where the driving cycle was as follows:
the PDD is initially accelerated to 100 rpm (low-speed rotor);
after 2 sec a load torque equivalent to the PDD rated torque of 100 Nm is applied on the low speed rotor for the duration of 3 sec;
the load is removed and the PDD continues to run unloaded for 1 sec before starting to decelerate to zero rpm;
the PDD is accelerated in reverse direction to −100 rpm and a load of 100 Nm is applied at the same time for 4 sec; and
the reference speed is set to zero at time t=14 sec, where the PDD decelerates and stops at time t=15 sec.

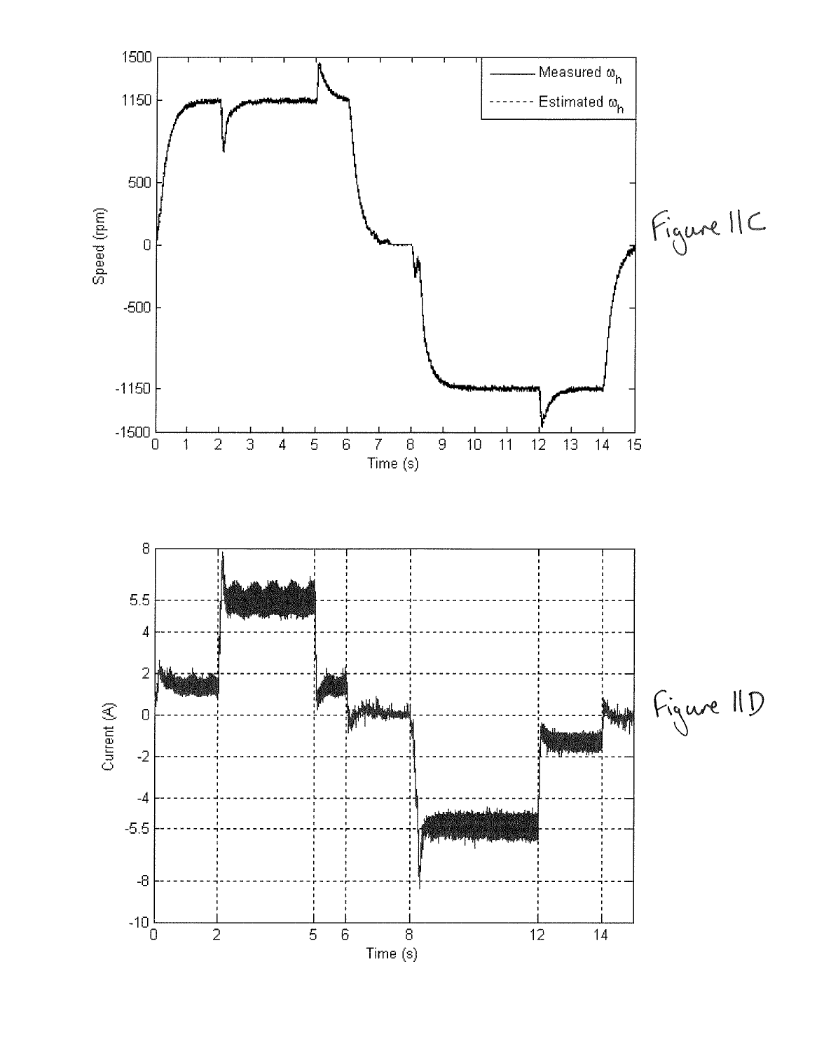

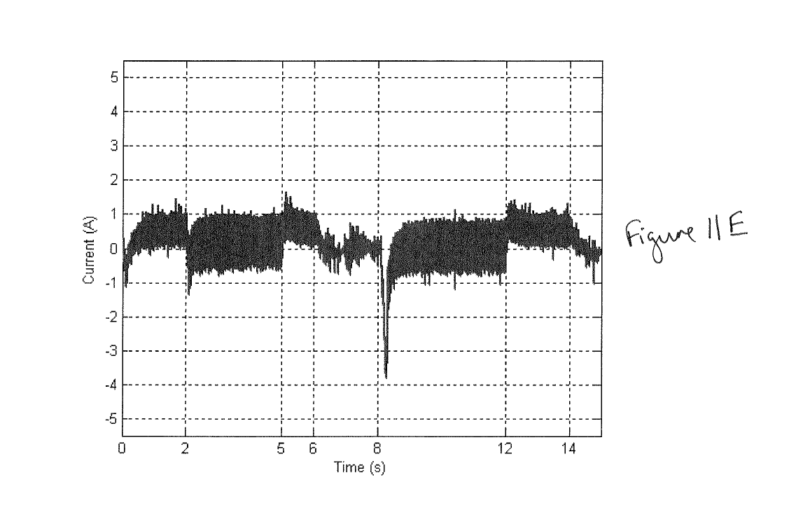

FIG. 11A shows the torque waveform of the driving cycle described above, and FIG. 11B shows the measured speed of the low-speed rotor during this driving cycle.

FIG. 11C shows measured and estimated speeds of the high-speed rotor; on this scale difference between the measured and estimated speeds is not perceptible. The PDD was driven in both directions to ensure that the angular position estimated for the high-speed rotor 10 is accurate in both directions. These are the results of a practical system, where the speed of the low speed rotor is directly measured using a sensor (incremental encoder). The estimated speed of the high-speed rotor was estimated using the observer in real time.

The PDD is operated in speed mode where the controller regulates the current for the PDD to follow a speed demand; once a torque is applied to the PDD the speed controller will keep tracking the speed demand by demanding more current to resist the load. As described above, in this test the PDD was accelerated to 100 rpm (low speed rotor), after 2 seconds a load torque equivalent to 100 Nm was applied by the load machine for 3 seconds, the torque was then removed at t=5 seconds and the PDD speed was set to zero at t=6 seconds. At time t=8 seconds the PDD was driven in the opposite direction while the load machine applied load torque equivalent to 100 Nm from stand still, at t=12 seconds the PDD kept driving at the same speed for another 2 seconds before it was decelerated and stopped at t=14 sec. As may be seen, the low-speed rotor of the PDD maintained speed tracking without being affected by the external load torque. The rated torque of the PDD used in this example is ˜100 Nm, and the load torque applied to the PDD was equivalent to its rated torque.

The dip in the speed noticed at time t=2 to 3 second and t=5 to 6 seconds is a normal transient response to load torque change; the steady state period is the period between 3 to 5 seconds and 9 to 12 seconds, where the PDD follows a set speed of 100 rpm under 100 Nm of load torque.

FIGS. 11D and 11E show the two components of the current, i_{q} and i_{d}, measured during the test described above; the current shown in FIG. 11D is i_{q}, and the current shown in FIG. 11E is i_{d}. i_{d} and i_{q} are the components of the current associated with the direct (d) and quadrature (q) axes respectively. i_{q} is the torque producing component of the current, while i_{d} has the effect of reducing the permanent magnet excitation flux by reducing the back emf resulting in reduced torque production. Reducing the torque using i_{d} is known as flux-weakening or field weakening control. In some PDD applications field weakening is desirable, since the speed range of the machine with a given maximum voltage is increased, although the torque per amp is decreased. The relation between the two components of current is governed by the commutation angle, and, when field weakening is required, the commutation angle may be altered to allow for the injection of d-axis current. However, in the test described above, the PDD is not operated in field weakening, and the i_{d} component of the current should be minimal.

In the test described above, maximum torque per amp is desired, in order that the PDD runs with maximum efficiency. Therefore, i_{d} is maintained as close to zero as possible to avoid field weakening. In this test, the estimated position of the high-speed rotor was used for commutation. If the high-speed rotor position estimation using the model-based observer is sufficiently accurate, i_{d} should be relatively close to zero throughout the test.

As may be seen in FIG. 11D, during the test described above the current i_{q} varies with the speed demand, and with the load torque. However, as shown in FIG. 11E, i_{d} remains close to zero over the course of the test. Therefore, the results of the test show that the estimation of the position of the high-speed rotor is sufficiently accurate to enable correct commutation.

The hardware and algorithm could be configured to accommodate a resolver or encoder in digital or analogue format for both for input and output use. Furthermore, both software and hardware may be easily integrated with the drive system 100, with the sensor 28 or built in stand-alone fashion where it could be used to link sensor 28 with the drive system 100 and be able to accommodate different protocols, as shown in FIGS. 7A, 7B and 7C.

While the embodiments above have been described in relation to a Pseudo Direct Drive machine, the above principles may be equally applied to any apparatus comprising a magnetic gear. In particular, a similar means for estimating the position of a rotor may be employed in an apparatus utilising a variable magnetic gear, such as those described in international patent publication WO 2009/103993 A1.

1. An apparatus comprising:
a first rotor having an angular position;
a second rotor which interacts with the first rotor in a magnetically geared manner;
a sensor for measuring a kinematic property of the second rotor;
means for estimating the angular position of the first rotor using a model-based observer, wherein the estimation is based on at least the kinematic property of the second rotor.

2-40. (canceled)
